(19) United States
(12) Patent Application Publication
(10) Pub. No.: US 2010/0180067 A1
(43) Pub. Date: Jul. 15, 2010

(54) SYSTEM FOR EMULATING AND EXPANDING A SPI CONFIGURATION ROM FOR IO ENCLOSURE

(75) Inventors: Enrique Q. Garcia, Tucson, AZ (US); Gary W. Batchelor, Tucson, AZ (US)

Correspondence Address: IBM CORPORATION US;c/o Suiter Swantz pc llo, 14301 FNB Parkway, Suite 220, Omaha, NE, 68154, US

(73) Assignee: INTERNATIONAL BUSINESS MACHINES CORPORATION, Armonk, NY (US)

(21) Appl. No.: 12/353,322

(22) Filed: Jan. 14, 2009

(51) Int. Cl. G06F 12/02

(52) U.S. Cl. 711/103; 711/E12.008

(57) ABSTRACT

The present disclosure is directed to a method for providing serial peripheral interface (SPI) access in an IO enclosure. The method may comprise receiving a SPI access request at a bus interface unit; sending the SPI access request to a register bus, the register bus connecting an internal ROM, at least one status register, and at least one control register; fetching from the internal ROM when the SPI access request is a read request for configuration information; reading from the at least one status register when the SPI access request is a read request for at least one of an indicator, a sensor, or a controller within the IO enclosure; and writing to the at least one control register when the SPI access request is a write request for at least one of the indicator, the sensor, or the controller within the IO enclosure.

### TECHNICAL FIELD

The present disclosure generally relates to the field of computer technology, and more particularly to a method for providing serial peripheral interface (SPI) access in an IO enclosure.

### BACKGROUND

A computer system may comprise a host connected to an IO enclosure via a PCI Express (PCIe) cable. A PCIe switch in the IO enclosure may distribute the primary PCIe link to a number of IO adapters. A PCIe switch may utilize a serial peripheral interface (SPI) electrically erasable programmable read-only memory (EEPROM) to load configuration information during initialization or power on sequences.

### SUMMARY

The present disclosure is directed to a method for providing serial peripheral interface (SPI) access in an IO enclosure. The method may comprise receiving a SPI access request at a bus interface unit; sending the SPI access request to a register bus, the register bus connecting an internal ROM, at least one status register, and at least one control register; fetching from the internal ROM when the SPI access request is a read request for configuration information; reading from the at least one status register when the SPI access request is a read request for at least one of an indicator, a sensor, or a controller within the IO enclosure; and writing to the at least one control register when the SPI access request is a write request for at least one of the indicator, the sensor, or the controller within the IO enclosure.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a block diagram of a generalized computer system having a host connected to an IO enclosure via a PCI Express (PCIe) cable;

FIG. 2 is a block diagram of another generalized computer system having a host connected to an IO enclosure via a PCIe cable; and

FIG. 3 is a flow diagram illustrating a method for providing serial peripheral interface (SPI) access in an IO enclosure.

### DETAILED DESCRIPTION

Reference will now be made in detail to the subject matter disclosed, which is illustrated in the accompanying drawings.

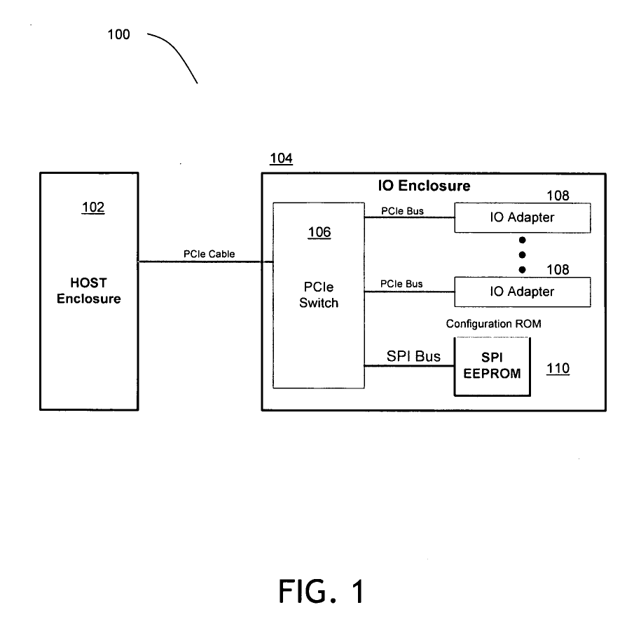

Referring now to FIG. 1, a block diagram of a generalized computer system 100 having a host 102 connected to an IO enclosure 104 via a PCI Express (PCIe) cable is shown. A PCIe switch 106 in the IO enclosure 104 may distribute the primary PCIe link to a number of 10 adapters 108. The PCIe switch 106 may utilize a serial peripheral interface (SPI) electrically erasable programmable read-only memory (EEPROM) 110 to load configuration information during initialization or power on sequences. However, the PCIe switch 106 may not be configured for providing a generalized connectivity and support for other non-PCIe specific IO enclosure indicators, sensors, and/or controllers.

The present disclosure is directed to a method and system for providing SPI access in an IO enclosure. A system may be configured for emulating and expanding SPI configuration ROM for IO enclosure monitoring and controlling. For example, the system may utilize a field-programmable gate array (FPGA) in the IO enclosure in lieu of a SPI EEPROM configuration, providing expanded and generalized support for indicators, sensors, and/or controllers, while emulating a configuration ROM for providing configuration information during initialization or power on sequences.

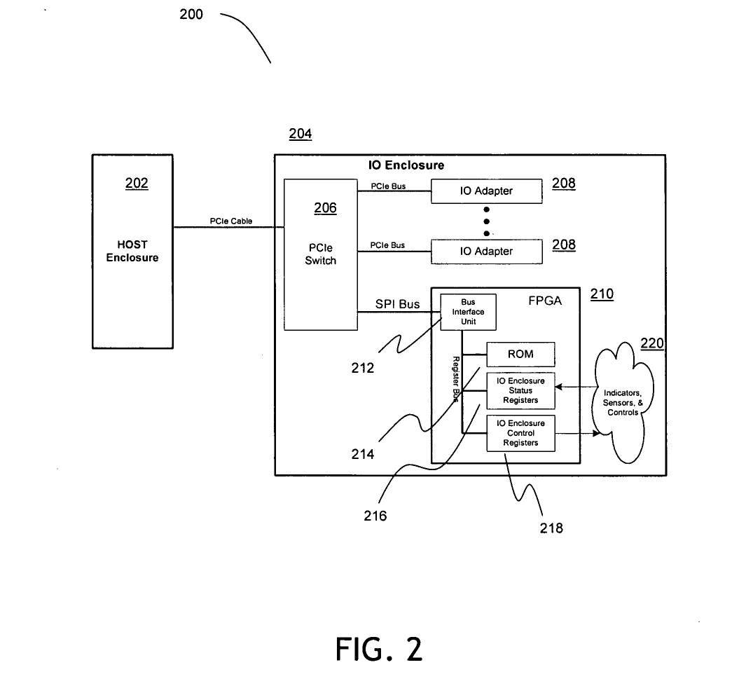

Referring now to FIG. 2, a block diagram of a computer system 200 having a host 202 connected to an IO enclosure 204 via a PCI Express (PCIe) cable is shown. A PCIe switch 206 in the IO enclosure 204 may distribute the primary PCIe link to a number of 10 adapters 208. In one embodiment, instead of a SPI EEPROM, the PCIe switch 206 may be connected to an FPGA 210 configured for emulating and expanding SPI configuration ROM for IO enclosure monitoring and controlling.

In one embodiment, the FPGA 210 may comprise a bus interface unit 212. The bus interface unit 212 may receive access (read or write) requests from the PCIe switch 206 via a SPI bus. Upon receiving an access request, the bus interface unit 212 may translate and send the access request on to a memory mapped internal register bus. The register bus may be configured for connecting an internal ROM 214, one or more status registers 216, and one or more control registers 218.

The internal ROM 214 may be configured to emulate the configuration ROM (FIG. 1) for providing configuration information during initialization or power on sequences. The status registers 216 may be configured for storing status information of non-PCIe specific IO enclosure indicators, sensors, and/or controllers 220. The control register 218 may be configured for accessing/controlling the non-PCIe specific IO enclosure indicators, sensors, and/or controllers 220.

The bus interface unit 212 may map a received access request to the internal register bus. For example, if the access request is a read request for configuration information during initialization, the read request may be mapped to the internal ROM 214 in order to fetch the requested configuration information. In another example, if the access request is a read request for status of a particular indicator, sensor, or controller, the request may be mapped to the corresponding status register 216 in order to read its current status. In still another example, if the access request is a write request to an indicator, sensor, or controller (e.g., to modify its status), then the request may be mapped to the corresponding control register 218 to perform the write request.

It is contemplated that the mapping may be carried out based on memory address ranges. For example, in one embodiment, configuration information stored in the internal ROM 214 may utilize a lower memory address range comparing to the memory address ranges utilized by the status and control registers. In this configuration, read requests from lower memory addresses may be mapped to the internal ROM, while read and/or write requests to upper memory addresses may be mapped to IO enclosure status and control registers.

It is also contemplated that the internal ROM 214 may be configured to be read-only from the SPI perspective (i.e., no write request to the configuration information may be initiated from the SPI bus). However, the internal ROM 214 may be indirectly updateable as part the FPGA configuration bit-stream.

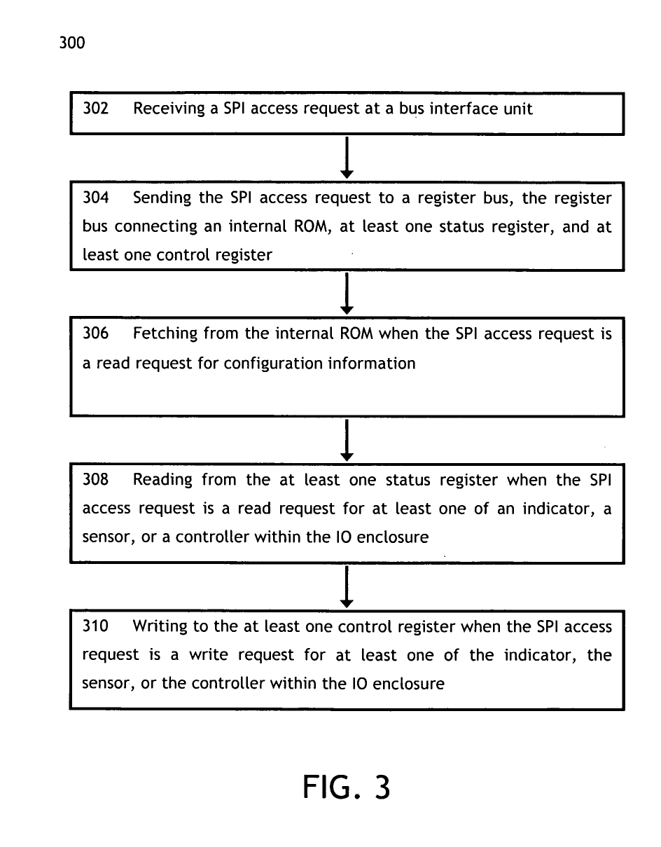

FIG. 3 shows a flow diagram illustrating steps performed by a method 300 in accordance with the present disclosure. The method 300 may be utilized for providing serial peripheral interface (SPI) access in an IO enclosure. Step 302 may receive a SPI access request at a bus interface unit 212. Step 304 may send the SPI access request to a register bus. The register bus may be configured for connecting an internal ROM 214, at least one status register 216, and at least one control register 218.

If the SPI access request is a read request for configuration information, the request may be mapped to the internal ROM 214, and step 306 may fetch the requested configuration information from the internal ROM. If the SPI access request is a read request for one of an indicator, a sensor, or a controller 220 within the IO enclosure, the request may be mapped to a corresponding status register, and step 308 may read the status information from the status register. If the SPI access request is a write request for one of the indicator, the sensor, or the controller 220 within the IO enclosure, the request may be mapped to a corresponding control register, and step 310 may perform the write request via the control register.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for providing serial peripheral interface (SPI) access in an IO enclosure, comprising:
receiving a SPI access request at a bus interface unit;
sending the SPI access request to a register bus, the register bus connecting an internal ROM, at least one status register, and at least one control register;
fetching from the internal ROM when the SPI access request is a read request for configuration information;
reading from the at least one status register when the SPI access request is a read request for at least one of an indicator, a sensor, or a controller within the IO enclosure; and
writing to the at least one control register when the SPI access request is a write request for at least one of the indicator, the sensor, or the controller within the IO enclosure.
